(19) United States
(12) Patent Application Publication
(10) Pub. No.: US 2012/0317380 A1
(43) Pub. Date: Dec. 13, 2012

(54) DEVICE AND METHOD FOR A HALF-RATE CLOCK ELASTICITY FIFO

(76) Inventors: Vikas Kumar AGRAWAL, Bangalore (IN); Srinivas Vura, San Jose, CA (US)

(21) Appl. No.: 13/158,376

(22) Filed: Jun. 11, 2011

(51) Int. Cl. G06F 12/02

(52) U.S. Cl. 711/159; 711/E12.002

(57) ABSTRACT

A device and method for processing an incoming data stream in a half-rate clock elasticity first in first out (FIFO) are disclosed. In one embodiment, two data blocks are written substantially simultaneously to two locations in the elasticity FIFO specified by respective two write pointers in a write clock cycle of a write clock. Further, two data blocks are read substantially simultaneously from two consecutive or non-consecutive locations in the elasticity FIFO specified by two read pointers in a read clock cycle of a read clock. The two read pointers can independently adjust locations to read in the plurality of locations based on a type of the data blocks in the elasticity FIFO and a predetermined elasticity FIFO threshold level in the read clock cycle to maintain the elasticity FIFO level at predetermined elasticity FIFO threshold level to achieve a constant output rate.

### TECHNICAL FIELD

The present invention relates generally to devices coupled to communication and storage systems, and more particularly to devices coupled to the communication and storage systems that use digital data with an embedded clock signal.

### BACKGROUND

Typically, devices connected to communication and storage systems have a variation in clock rate between a transmitter and a receiver and this can, very often, result in varying incoming and outgoing data transfer rates between the devices. When a data stream enters a device at a higher or lower data transfer rate than the device clock rate, then an adjustment to the incoming data transfer rate with respect to the device clock rate is needed to avoid any loss of data due to resulting overflow or underflow condition. Generally, such a condition is overcome by using an elasticity first in first out (FIFO) in the receiving data path of the device. Further, special signatures are embedded in the incoming data stream to form special symbols, which are referred to as “skip symbols”, to the elasticity FIFO to adjust the difference in the incoming and outgoing data transfer rates. Typically, each symbol includes about 10 bits of data that is stored in a location in the elasticity FIFO. The adjustment to the data transfer rates is made on read side of the elasticity FIFO by either jumping a read pointer to skip one or more skip symbols or holding the read pointer at the skip symbols based on a difference in the incoming and outgoing data transfer rates. Existing elasticity FIFOs may require higher clock rate based on speed of data transmission and hence can result in implementation complexity and higher power consumption.

### SUMMARY

A device and method for a half-rate clock elasticity first in first out (FIFO) are disclosed. According to one aspect of the present subject matter, the method includes writing two data blocks substantially simultaneously to two locations in the elasticity FIFO specified by respective two write pointers in a write clock cycle of a write clock. Further, the method includes reading two data blocks substantially simultaneously from two consecutive or non-consecutive locations in the elasticity FIFO specified by two read pointers in a read clock cycle of a read clock. The two read pointers can independently adjust locations to read in a plurality of locations based on a type of data blocks in the elasticity FIFO and a predetermined elasticity FIFO threshold level in the read clock cycle to maintain an elasticity FIFO level at the predetermined elasticity FIFO threshold level to achieve a constant output rate.

According to another aspect of the present subject matter, the device coupled to a communication or storage system for receiving data from a network includes a write pointer generation module, a read pointer generation module coupled to the write pointer generation module, and the elasticity FIFO coupled to the write pointer generation module and the read pointer generation module. Further, the elasticity FIFO includes the plurality of locations to temporarily store data blocks.

The write pointer generation module generates the two write pointers and writes two data blocks substantially simultaneously to two locations in the elasticity FIFO specified by the respective two write pointers in the write clock cycle of the write clock. Further, the read pointer generation module generates the two read pointers and reads two data blocks substantially simultaneously from two consecutive or non-consecutive locations in the elasticity FIFO specified by the two read pointers in the read clock cycle of the read clock. The two read pointers independently adjust locations to read in the plurality of locations based on the type of the data blocks in the elasticity FIFO and the predetermined elasticity FIFO threshold level in the read clock cycle to maintain the elasticity FIFO level at the predetermined elasticity FIFO threshold level to achieve the constant output rate.

The device and methods disclosed herein may be implemented in any means for achieving various aspects, and other features will be apparent from the accompanying drawings and from the detailed description that follows.

### BRIEF DESCRIPTION OF THE DRAWINGS

Various embodiments are described herein with reference to the drawings, wherein:

FIG. 1 illustrates a block diagram of a half-rate clock elasticity first in first out (FIFO) device including major elements in a standard communication protocol, according to an embodiment of the invention;

FIGS. 2-6 are schematic illustrations of elasticity FIFOs, such as those shown in FIG. 1, with two write and two read pointers making before and after adjustments to synchronize data transfer rate between a transmitter and a receiver in various scenarios when an elasticity FIFO level is above a predetermined elasticity FIFO threshold level, according to an embodiment of the invention;

FIG. 7 is a schematic illustration of elasticity FIFOs, such as those shown in FIG. 1, with two write and two read pointers making before and after adjustments to synchronize data transfer rate between the transmitter and the receiver in a scenario when an elasticity FIFO level is equal to the predetermined elasticity FIFO threshold level, according to an embodiment of the invention;

FIGS. 8, and 9A-B are schematic illustrations of elasticity FIFOs, such as those shown in FIG. 1, with two write and two read pointers making before and after adjustments to synchronize data transfer rate between the transmitter and the receiver in various scenarios when an elasticity FIFO level is below the predetermined elasticity FIFO threshold level, according to an embodiment of the invention;

FIG. 10 is a flow diagram illustrating a method for processing an incoming data stream using the half-rate clock elasticity FIFO device, such as the one shown in FIG. 1, according to an embodiment of the invention; and

FIG. 11 is another flow diagram illustrating a method for processing the incoming data stream using the half-rate clock elasticity FIFO device, such as the one shown in FIG. 1, according to an embodiment of the invention.

The drawings described herein are for illustration purposes only and are not intended to limit the scope of the present invention in any way.

### DETAILED DESCRIPTION

A device and method for data processing using a half-rate elasticity first in first out (FIFO) are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The term “skip symbol” refers to a special character symbol which is different from normal data symbols and is not intended to carry any data, and included as a standard part of an incoming data stream.

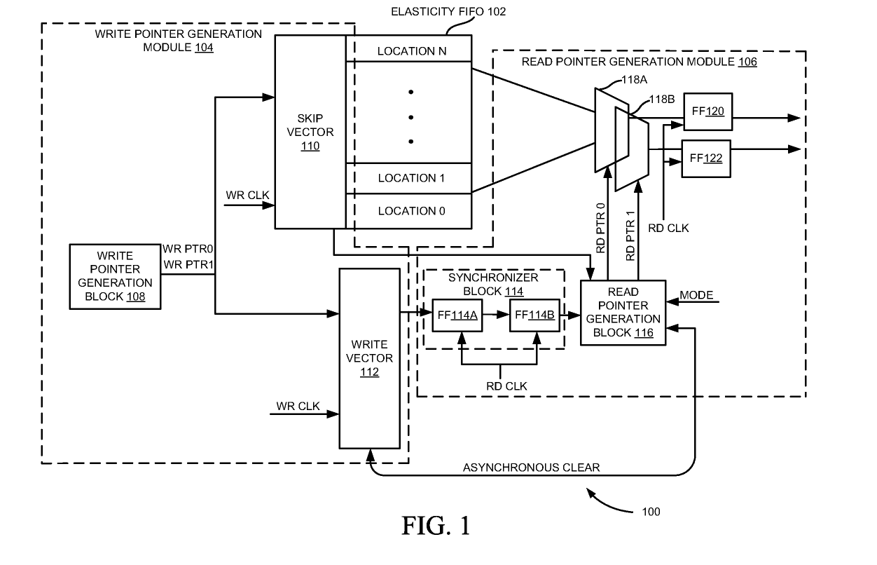

Referring now to FIG. 1, which illustrates a block diagram of a half-rate clock elasticity FIFO device 100 including major elements in a standard communication protocol, according to an embodiment of the invention. As shown in FIG. 1, the device 100 includes an elasticity FIFO 102, a write pointer generation module 104, and a read pointer generation module 106. Further, the elasticity FIFO 102 includes a plurality of locations to temporarily store data blocks. Furthermore, the write pointer generation module 104 includes a write pointer generation block 108, a skip vector 110, and a write vector 112. Also, the read pointer generation module 106 includes a synchronizer block 114, a read pointer generation block 116, multiplexers 118A and 118B, and timing flip-flops (FFs) 120 and 122. In addition, the synchronizer block 114 includes FFs 114A and 114B.

As shown in FIG. 1, the elasticity FIFO 102 is coupled to the write pointer generation module 104 and the read pointer generation module 106. Further, the read pointer generation module 106 is coupled to the write pointer generation module 104. In one exemplary implementation, the write pointer generation block 108 is coupled to the skip vector 110 and the write vector 112. Further, the skip vector 110 is coupled to the elasticity FIFO 102 and the read pointer generation block 116.

Further as shown in FIG. 1, the synchronizer block 114 is coupled between the write vector 112 and the read pointer generation block 116. Furthermore as shown in FIG. 1, the read pointer generation block 116 is coupled to the timing FFs 120 and 122 via the multiplexers 118A and 118B. In addition, the multiplexers 118A and 118B are communicatively coupled to the elasticity FIFO 102.

In operation, the write pointer generation block 108 generates two write pointers WR PTR0 and WR PTR1. The two write pointers WR PTR0 and WR PTR1 provide address of locations in the elasticity FIFO 102 where the data blocks are written. The write pointer generation block 108 writes two data blocks substantially simultaneously at two locations in the elasticity FIFO 102 specified by the two write pointers WR PTR0 and WR PTR1. Each of the two write pointers WR PTR0 and WR PTR1 is advanced by two locations in the elasticity FIFO 102 in each write clock cycle when a write operation is enabled. Based on the two write pointers WR PTR0 and WR PTR1, two data blocks are continuously loaded to two locations in the elasticity FIFO 102. Further, the skip vector 110 includes information about the locations in the elasticity FIFO 102 holding skip symbols corresponding to the write pointers WR PTR0 and WR PTR1. In addition, the write vector 112 includes information about the number of locations in the elasticity FIFO 102, which includes the data blocks corresponding to the write pointers WR PTR0 and WR PTR1.

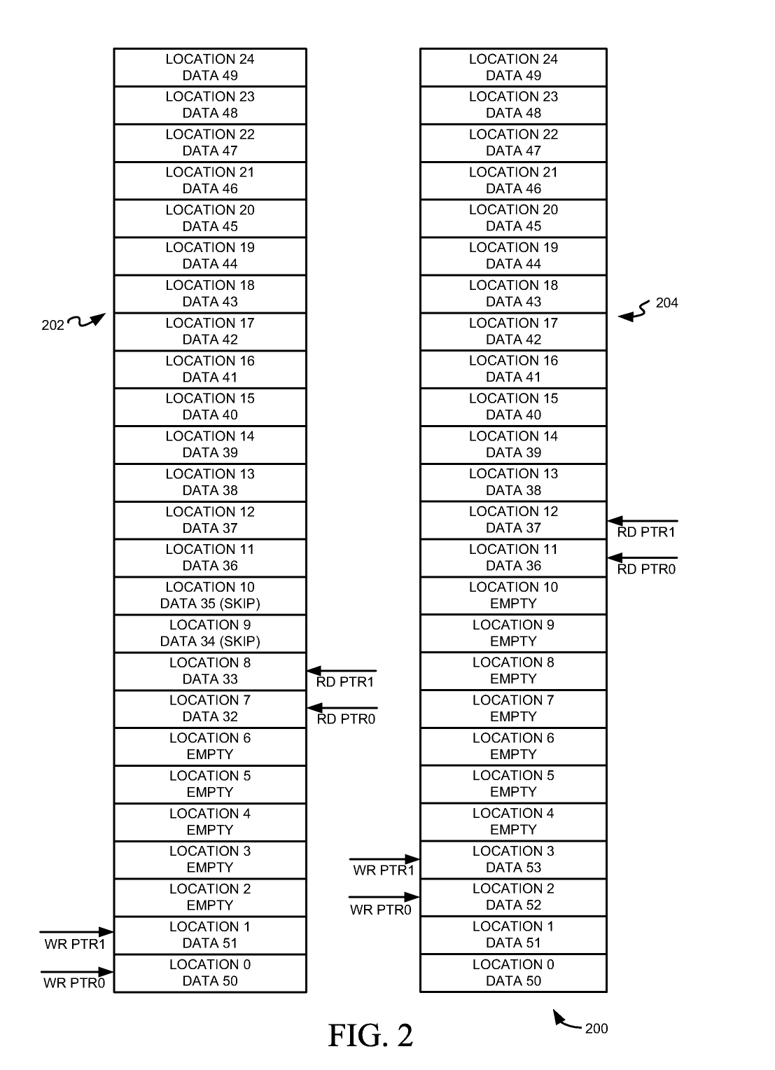

Further in operation, the read pointer generation block 116 generates read pointers RD PTR0 and RD PTR1. After the data blocks are written, at least two data blocks are substantially simultaneously read from the elasticity FIFO 102 using the two read pointers RD PTR0 and RD PTR1 based on a type of data blocks in the elasticity FIFO and a predetermined elasticity FIFO threshold level. Exemplary data blocks include data blocks and/or skip symbols. The two read pointers RD PTR0 and RD PTR1 provide address of the locations from where the data blocks are read in the elasticity FIFO 102 in a read clock cycle. Based on the two read pointers RD PTR0 and RD PTR1, the data blocks are unloaded from the locations in the elasticity FIFO 102 and then sent to a receive path logic via the multiplexers 118A and 118B and the timing FFs 120 and 122. In these embodiments, the synchronizer block 114 is used to synchronize data transfer rate between a write clock WR CLK and a read clock RD CLK. Further, the timing FFs 120 and 122 are used to register output from the multiplexers 118A and 118B before sending to the receive path logic. This process continues until all the locations in the elasticity FIFO 102 are read. The read pointers RD PTR0 and RD PTR1 operate independent of each other and simultaneously read two data blocks. During normal operation, each of the two read pointers RD PTR0 and RD PTR1 is advanced by two locations in each read clock cycle when a read operation is enabled. The two read pointers RD PTR0 and RD PTR1 independently adjust locations in the elasticity FIFO 102 to read in the plurality of locations based on the type of the data blocks in the elasticity FIFO 102 and the predetermined elasticity FIFO threshold level in the read clock cycle to maintain an elasticity FIFO level at the predetermined elasticity FIFO threshold level to achieve a constant output rate. This is explained in more detail with respect to FIGS. 2-9.

Referring now to FIG. 2, a schematic illustrates elasticity FIFOs 202 and 204 (e.g., the elasticity FIFO 102 in FIG. 1) with two write and two read pointers making before and after adjustments to synchronize data transfer rate between a transmitter and a receiver in a scenario when an elasticity FIFO level is above the predetermined elasticity FIFO threshold level, according to an embodiment of the invention. The elasticity FIFOs 202 and 204 includes twenty four locations to temporarily store the data blocks. Initially, the two write pointers WR PTR0 and WR PTR1 start at locations 0 and 1, respectively, and two data blocks are written to the two locations, i.e., locations 0 and 1 respectively. The two write pointers WR PTR0 and WR PTR1 increment to the next successive location after each data block is written into the elasticity FIFOs 202 and 204 until the data blocks are written to the last location, i.e., location 24. After the data blocks are written to the last location, the two write pointers WR PTR0 and WR PTR1 return to the locations 0 and 1, respectively, and the write process is repeated until the device is stopped. In one exemplary implementation, the write operation is performed in each write clock cycle of the write clock WR CLK. The write clock WR CLK is usually a clock embedded with the incoming data stream.

Similarly, the two read pointers RD PTR0 and RD PTR1 initially start at two locations 0 and 1, respectively, and two data blocks are read from the two locations, i.e., locations 0 and 1 respectively. The read process begins when the two write pointers WR PTR0 and WR PTR1 reach the predetermined elasticity FIFO threshold level. The two read pointers RD PTR0 and RD PTR1 increment to the next successive location after each data block is read from the elasticity FIFOs 202 and 204 until the data block is read from the last location, i.e., location 24. After data block is read from the last location, the two read pointers RD PTR0 and RD PTR1 return to the locations 0 and 1, respectively, and the read process is repeated until the device is stopped. In one exemplary implementation, a read operation is performed in each read clock cycle of the read clock RD CLK. The read clock RD CLK is an internal clock of the receiver.

Further, the elasticity FIFO 202 illustrates positions of the two write and two read pointers before the adjustments in a clock cycle (e.g., n). The two write pointers WR PTR0 and WR PTR1 write two data blocks (including data 50 and data 51) substantially simultaneously to two locations, i.e., locations 0 and 1, respectively, in the elasticity FIFO 202. The two read pointers RD PTR0 and RD PTR1 read two data blocks (including data 32 and data 33) substantially simultaneously from two locations, i.e., locations 7 and 8, respectively, in the elasticity FIFO 202. In this embodiment, two consecutive locations, i.e., locations 9 and 10, in the elasticity FIFO 202 hold skip symbols (including data 34 and data 35).

Furthermore, the elasticity FIFO 204 illustrates positions of the two write and two read pointers after the adjustments in a next clock cycle (e.g., n+1). The two write pointers WR PTR0 and WR PTR1 write two data blocks (including data 52 and data 53) substantially simultaneously to two locations, i.e., locations 2 and 3, respectively, in the elasticity FIFO 204. The two read pointers RD PTR0 and RD PTR1 read two data blocks (including data 36 and data 37) substantially simultaneously from two locations, i.e., locations 11 and 12, respectively, upon skipping the two consecutive locations (i.e., locations 9 and 10) that are holding the skip symbols in the elasticity FIFO 204. The read pointer RD PTR0 skips the two consecutive locations (i.e., locations 9 and 10) that are holding the skip symbols and moves to next location, i.e., location 11, in the elasticity FIFO 204. The read pointer RD PTR1 moves to next location, i.e., location 12, in the elasticity FIFO 204.

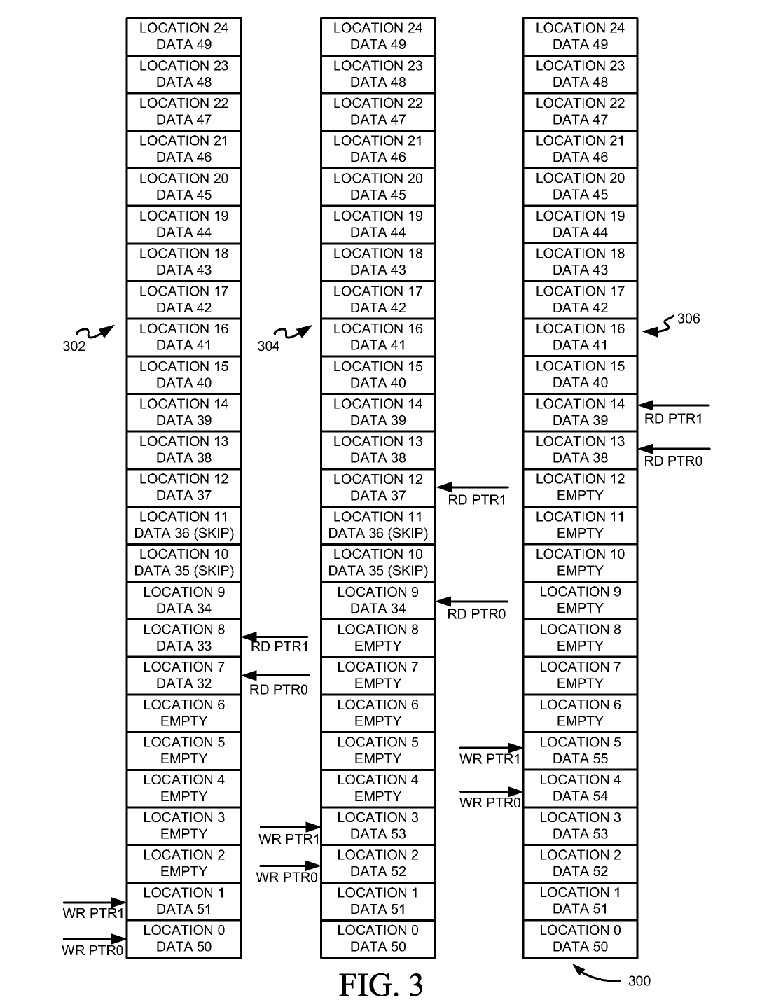

Referring now to FIG. 3, a schematic illustrates elasticity FIFOs 302, 304, and 306 (e.g., the elasticity FIFO 102 in FIG. 1) with two write and two read pointers making before and after adjustments to synchronize data transfer rate between the transmitter and the receiver in another scenario when an elasticity FIFO level is above the predetermined elasticity FIFO threshold level, according to an embodiment of the invention. The elasticity FIFOs 302, 304, and 306 are similar to the elasticity FIFOs 202 and 204 shown in FIG. 2. Further, the elasticity FIFO 302 illustrates positions of the two write and two read pointers before adjustments in a clock cycle (e.g., n). The two write pointers WR PTR0 and WR PTR1 write two data blocks (including data 50 and data 51) substantially simultaneously to two locations, i.e., locations 0 and 1, respectively, in the elasticity FIFO 302. The two read pointers RD PTR0 and RD PTR1 read two data blocks (including data 32 and data 33) substantially simultaneously from two locations, i.e., locations 7 and 8, respectively, in the elasticity FIFO 302. In this embodiment, two consecutive locations, i.e., locations 10 and 11, in the elasticity FIFO 302 hold skip symbols (including data 35 and data 36).

Furthermore, the elasticity FIFO 304 illustrates positions of the two write and two read pointers after the adjustments in a next clock cycle (e.g., n+1). The two write pointers WR PTR0 and WR PTR1 write two data blocks (including data 52 and data 53) substantially simultaneously to two locations, i.e., locations 2 and 3, respectively, in the elasticity FIFO 304. The two read pointers RD PTR0 and RD PTR1 read two data blocks (including data 34 and data 37) substantially simultaneously from two locations, i.e., locations 9 and 12, respectively, upon skipping the two consecutive locations (i.e., locations 10 and 11) that are holding the skip symbols in the elasticity FIFO 304. The RD PTR0 moves to next location, i.e., location 9, in the elasticity FIFO 304. The RD PTR1 skips the two consecutive locations (i.e., locations 10 and 11) that are holding the skip symbols (including data 35 and data 36) and moves to next location, i.e., location 12, in the elasticity FIFO 304.

In addition, the elasticity FIFO 306 illustrates positions of the two write and two read pointers after the adjustments in a next clock cycle (e.g., n+2). The two write pointers WR PTR0 and WR PTR1 write two data blocks (including data 54 and data 55) substantially simultaneously to two locations, i.e., locations 4 and 5, respectively, in the elasticity FIFO 306. The two read pointers RD PTR0 and RD PTR1 read two data blocks (including data 38 and data 39) substantially simultaneously from two locations, i.e., locations 13 and 14, respectively, in the elasticity FIFO 306.

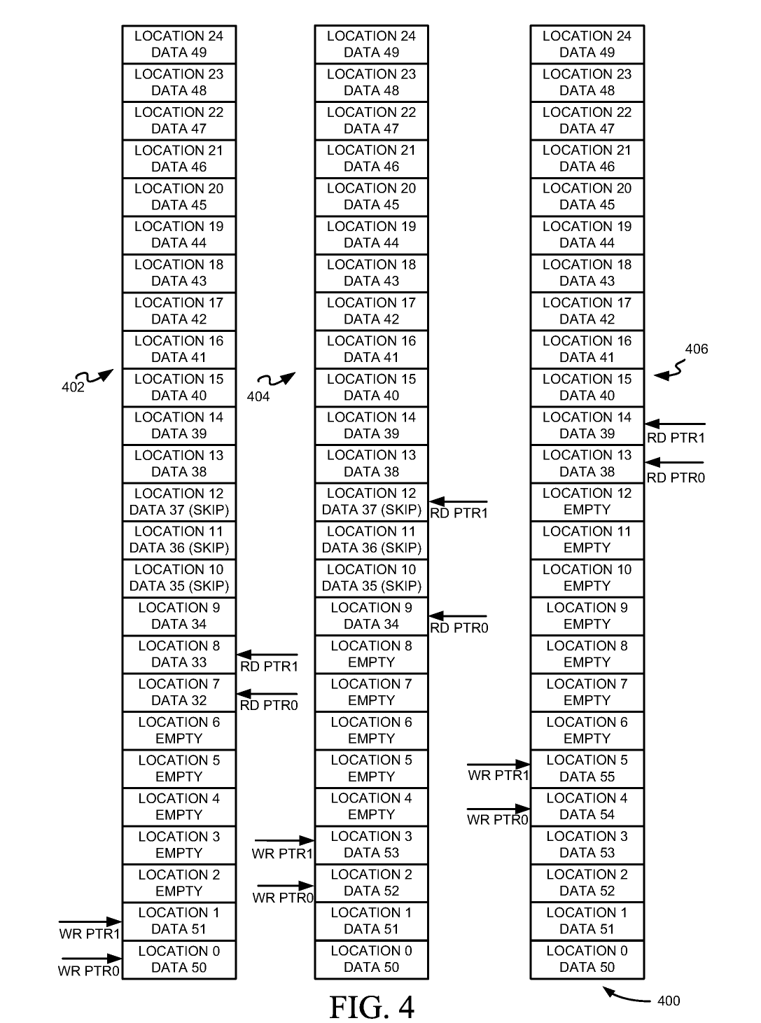

Referring now to FIG. 4, a schematic illustrates elasticity FIFOs 402, 404, and 406 (e.g., the elasticity FIFO 102 in FIG. 1) with two write and two read pointers making before and after adjustments to synchronize data transfer rate between the transmitter and the receiver in yet another scenario when an elasticity FIFO level is above the predetermined elasticity FIFO threshold level, according to an embodiment of the invention. The elasticity FIFOs 402, 404, and 406 are similar to the elasticity FIFOs 202 and 204 shown in FIG. 2. Further, the elasticity FIFO 402 illustrates positions of the two write and two read pointers before adjustments in a clock cycle (e.g., n). The two write pointers WR PTR0 and WR PTR1 write two data blocks (including data 50 and data 51) substantially simultaneously to two locations, i.e., locations 0 and 1, respectively, in the elasticity FIFO 402. The two read pointers RD PTR0 and RD PTR1 read two data blocks (including data 32 and data 33) substantially simultaneously from two locations, i.e., locations 7 and 8, respectively, in the elasticity FIFO 402. In this embodiment, three consecutive locations, i.e., locations 10, 11, and 12, in the elasticity FIFO 402 hold skip symbols (including data 35, data 36, and data 37).

Furthermore, the elasticity FIFO 404 illustrates positions of the two write and two read pointers after the adjustments in a next clock cycle (e.g., n+1). The two write pointers WR PTR0 and WR PTR1 write two data blocks (including data 52 and data 53) substantially simultaneously to two locations, i.e., locations 2 and 3, respectively, in the elasticity FIFO 404. The two read pointers RD PTR0 and RD PTR1 read two data blocks (including data 34 and data 37) substantially simultaneously from two locations, i.e., locations 9 and 12, respectively, upon skipping a part or all of the locations holding the skip symbols in the elasticity FIFO 404. The RD PTR0 moves to next location, i.e., location 9, in the elasticity FIFO 404. The RD PTR1 skips the two consecutive locations (i.e., locations 10 and 11) that are holding the skip symbols and moves to next location, i.e., location 12, in the elasticity FIFO 404. The pair of skip symbols (including data 35 and data 36) in the two consecutive locations, i.e., locations 10 and 11, is skipped and the third skip symbol (including data 37) in location 12 is read normally in the elasticity FIFO 404.

In addition, the elasticity FIFO 406 illustrates positions of the two write and two read pointers after the adjustments in a next clock cycle (e.g., n+2). The two write pointers WR PTR0 and WR PTR1 write two data blocks (including data 54 and data 55) substantially simultaneously to two locations, i.e., locations 4 and 5, respectively, in the elasticity FIFO 406. The two read pointers RD PTR0 and RD PTR1 read two data blocks (including data 38 and data 39) substantially simultaneously from two locations, i.e., locations 13 and 14, respectively, in the elasticity FIFO 406.

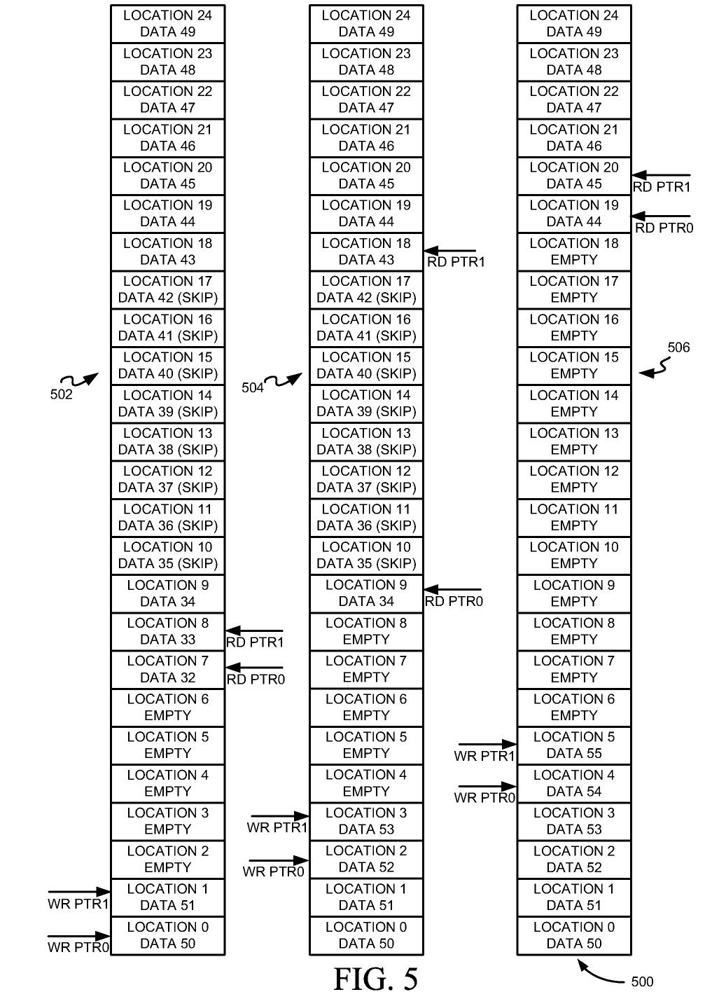

Referring now to FIG. 5, a schematic illustrates elasticity FIFOs 502, 504, and 506 (e.g., the elasticity FIFO 102 in FIG. 1) with two write and two read pointers making before and after adjustments to synchronize data transfer rate between the transmitter and the receiver in a scenario when an elasticity FIFO level is above the predetermined elasticity FIFO threshold level, according to an embodiment of the invention. The elasticity FIFOs 502, 504, and 506 are similar to the elasticity FIFOs 202 and 204 shown in FIG. 2. Further, the elasticity FIFO 502 illustrates positions of the two write and two read pointers before adjustments in a clock cycle (e.g., n). The two write pointers WR PTR0 and WR PTR1 write two data blocks (including data 50 and data 51) substantially simultaneously to two locations, i.e., locations 0 and 1, respectively, in the elasticity FIFO 502. The two read pointers RD PTR0 and RD PTR1 read two data blocks (including data 32 and data 33) substantially simultaneously from two locations, i.e., locations 7 and 8, respectively, in the elasticity FIFO 502. In this embodiment, eight consecutive locations, i.e., locations 10-17, in the elasticity FIFO 502 hold skip symbols (including data 35-42).

Furthermore, the elasticity FIFO 504 illustrates positions of the two write and two read pointers after the adjustments in a next clock cycle (e.g., n+1). The two write pointers WR PTR0 and WR PTR1 write two data blocks (including data 52 and data 53) substantially simultaneously to two locations, i.e., locations 2 and 3, respectively, in the elasticity FIFO 504. The two read pointers RD PTR0 and RD PTR1 read two data blocks (including data 34 and data 43) substantially simultaneously from two locations, i.e., locations 9 and 18, respectively, upon skipping the eight consecutive locations (i.e., locations 10-17) that are holding the skip symbols in the elasticity FIFO 504. The RD PTR0 moves to next location, i.e., location 9, in the elasticity FIFO 504. The RD PTR1 skips the eight consecutive locations (i.e., locations 10-17) that are holding the skip symbols (including data 35-42) and moves to next location, i.e., location 18, in the elasticity FIFO 504.

In addition, the elasticity FIFO 506 illustrates positions of the two write and two read pointers after the adjustments in a next clock cycle (e.g., n+2). The two write pointers WR PTR0 and WR PTR1 write two data blocks (including data 54 and data 55) substantially simultaneously to two locations, i.e., locations 4 and 5, respectively, in the elasticity FIFO 506. The two read pointers RD PTR0 and RD PTR1 read two data blocks (including data 44 and data 45) substantially simultaneously from two locations, i.e., locations 19 and 20, respectively, in the elasticity FIFO 506.

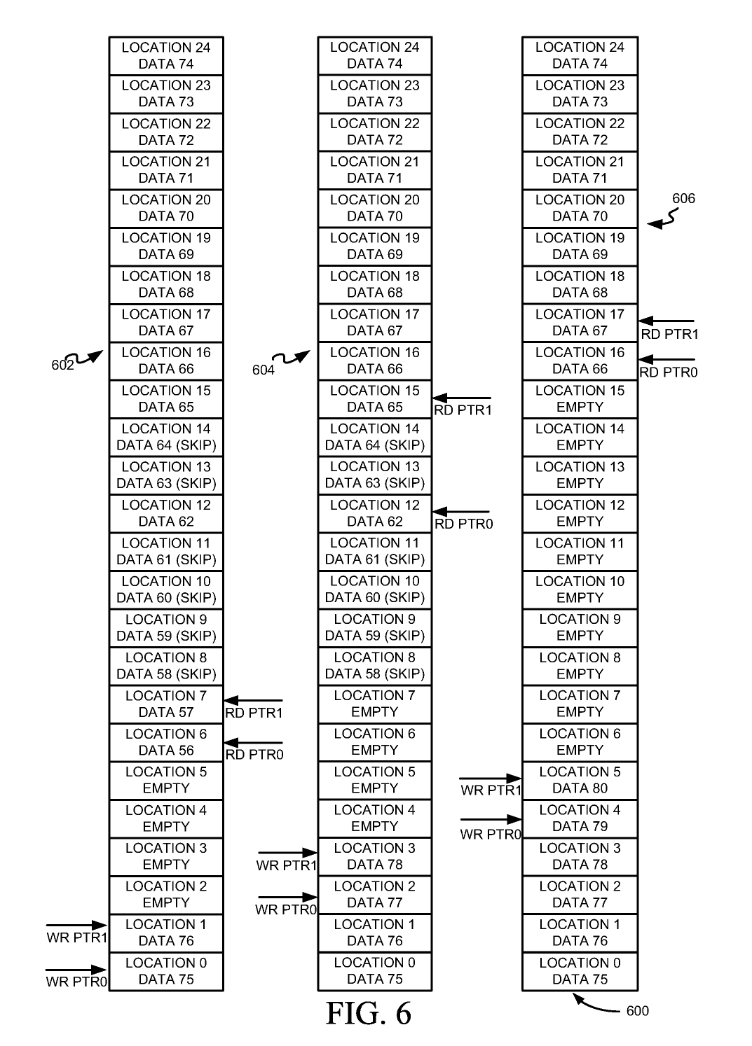

Referring now to FIG. 6, a schematic illustrates elasticity FIFOs 602, 604, and 606 (e.g., the elasticity FIFO 102 in FIG. 1) with two write and two read pointers making before and after adjustments to synchronize data transfer rate between the transmitter and the receiver in another scenario when an elasticity FIFO level is above the predetermined elasticity FIFO threshold level, according to an embodiment of the invention. The elasticity FIFOs 602, 604, and 606 are similar to the elasticity FIFOs 202 and 204 shown in FIG. 2. Further, the elasticity FIFO 602 illustrates positions of the two write and two read pointers before adjustments in a clock cycle (e.g., n). The two write pointers WR PTR0 and WR PTR1 write two data blocks (including data 75 and data 76) substantially simultaneously to two locations, i.e., locations 0 and 1, respectively, in the elasticity FIFO 602. The two read pointers RD PTR0 and RD PTR1 read two data blocks (including data 56 and data 57) substantially simultaneously from two locations, i.e., locations 6 and 7, respectively, in the elasticity FIFO 602. In this embodiment, four consecutive locations, i.e., locations 8-11, in the elasticity FIFO 602 hold skip symbols (including data 58-61). Further in this embodiment, two consecutive locations, i.e., locations 13 and 14, in the elasticity FIFO 602 hold skip symbols (including data 63 and data 64).

Furthermore, the elasticity FIFO 604 illustrates positions of the two write and two read pointers after the adjustments in a next clock cycle (e.g., n+1). The two write pointers WR PTR0 and WR PTR1 write two data blocks (including data 77 and data 78) substantially simultaneously to two locations, i.e., locations 2 and 3, respectively, in the elasticity FIFO 604. The two read pointers RD PTR0 and RD PTR1 read two data blocks (including data 62 and data 65) substantially simultaneously from two locations, i.e., locations 12 and 15, respectively, upon skipping the locations holding the skip symbols in the elasticity FIFO 604. The RD PTR0 skips the four consecutive locations (i.e., locations 8-11) that are holding the skip symbols (including data 58-61) and moves to next location, i.e., location 12, in the elasticity FIFO 604. The RD PTR1 skips the two consecutive locations (i.e., locations 13 and 14) that are holding the skip symbols (including data 63 and data 64) and moves to next location, i.e., location 15, in the elasticity FIFO 604.

In addition, the elasticity FIFO 606 illustrates positions of the two write and two read pointers after the adjustments in a next clock cycle (e.g., n+2). The two write pointers WR PTR0 and WR PTR1 write two data blocks (including data 79 and data 80) substantially simultaneously to two locations, i.e., locations 4 and 5, respectively, in the elasticity FIFO 606. The two read pointers RD PTR0 and RD PTR1 read two data blocks (including data 66 and data 67) substantially simultaneously from two locations, i.e., locations 16 and 17, respectively, in the elasticity FIFO 606.

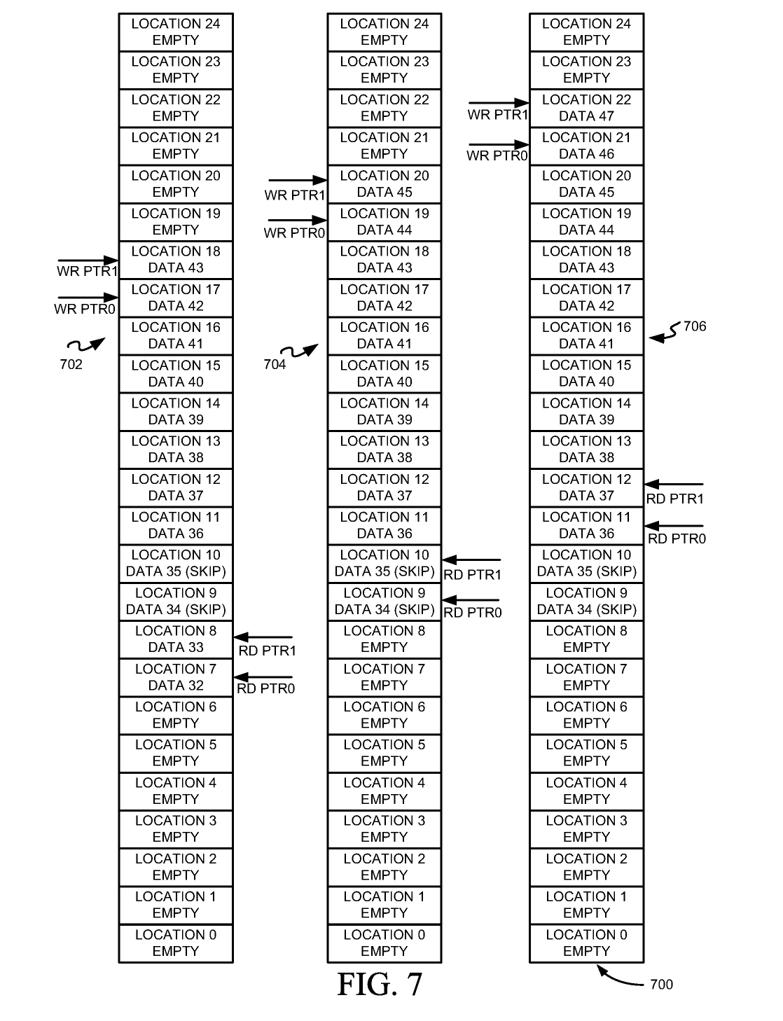

Referring now to FIG. 7, a schematic illustrates elasticity FIFOs 702, 704, and 706 (e.g., the elasticity FIFO 102 in FIG. 1) with two write and two read pointers making before and after adjustments to synchronize data transfer rate between the transmitter and the receiver in a scenario when an elasticity FIFO level is equal to the predetermined elasticity FIFO threshold level, according to an embodiment of the invention. The elasticity FIFOs 702, 704, and 706 are similar to the elasticity FIFOs 202 and 204 shown in FIG. 2. Further, the elasticity FIFO 702 illustrates positions of the two write and two read pointers before adjustments in a clock cycle (e.g., n). The two write pointers WR PTR0 and WR PTR1 write two data blocks (including data 42 and data 43) substantially simultaneously to two locations, i.e., locations 17 and 18, respectively, in the elasticity FIFO 702. The two read pointers RD PTR0 and RD PTR1 read two data blocks (including data 32 and data 33) substantially simultaneously from two locations, i.e., locations 7 and 8, respectively, in the elasticity FIFO 702. In this embodiment, two consecutive locations, i.e., locations 9 and 10, in the elasticity FIFO 702 hold skip symbols (including data 34 and data 35).

Furthermore, the elasticity FIFO 704 illustrates positions of the two write and two read pointers after the adjustments in a next clock cycle (e.g., n+1). The two write pointers WR PTR0 and WR PTR1 write two data blocks (including data 44 and data 45) substantially simultaneously to two locations, i.e., locations 19 and 20, respectively, in the elasticity FIFO 704. The two read pointers RD PTR0 and RD PTR1 read two data blocks (including data 34 and data 35) substantially simultaneously from two locations, i.e., locations 9 and 10, respectively, without skipping the two consecutive locations (i.e., locations 9 and 10) that are holding the skip symbols in the elasticity FIFO 704.

In addition, the elasticity FIFO 706 illustrates positions of the two write and two read pointers after the adjustments in a next clock cycle (e.g., n+2). The two write pointers WR PTR0 and WR PTR1 write two data blocks (including data 46 and data 47) substantially simultaneously to two locations, i.e., locations 21 and 22, respectively, in the elasticity FIFO 706. The two read pointers RD PTR0 and RD PTR1 read two data blocks (including data 36 and data 37) substantially simultaneously from two locations, i.e., locations 11 and 12, respectively, in the elasticity FIFO 706.

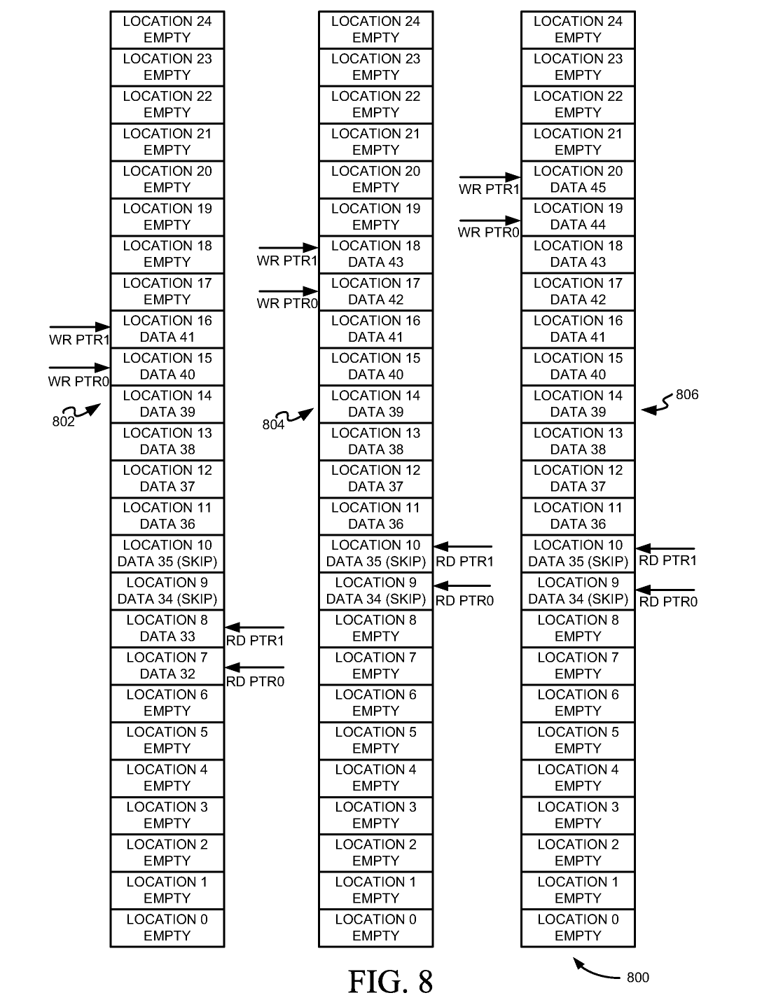

Referring now to FIG. 8, a schematic illustrates elasticity FIFOs 802, 804, and 806 (e.g., the elasticity FIFO 102 in FIG. 1) with two write and two read pointers making before and after adjustments to synchronize data transfer rate between the transmitter and the receiver in a scenario when an elasticity FIFO level is below the predetermined elasticity FIFO threshold level, according to an embodiment of the invention. The elasticity FIFOs 802, 804, and 806 are similar to the elasticity FIFOs 202 and 204 shown in FIG. 2. Further, the elasticity FIFO 802 illustrates positions of the two write and two read pointers before adjustments in a clock cycle (e.g., n). The two write pointers WR PTR0 and WR PTR1 write two data blocks (including data 40 and data 41) substantially simultaneously to two locations, i.e., locations 15 and 16, respectively, in the elasticity FIFO 802. The two read pointers RD PTR0 and RD PTR1 read two data blocks (including data 32 and data 33) substantially simultaneously from two locations, i.e., locations 7 and 8, respectively, in the elasticity FIFO 802. In this embodiment, two consecutive locations, i.e., locations 9 and 10, in the elasticity FIFO 802 hold skip symbols (including data 34 and data 35).

Furthermore, the elasticity FIFO 804 illustrates positions of the two write and two read pointers after the adjustments in a next clock cycle (e.g., n+1). The two write pointers WR PTR0 and WR PTR1 write two data blocks (including data 42 and data 43) substantially simultaneously to two locations, i.e., locations 17 and 18, respectively, in the elasticity FIFO 804. The two read pointers RD PTR0 and RD PTR1 read two data blocks (including data 34 and data 35) substantially simultaneously from two locations, i.e., locations 9 and 10, respectively, without skipping the two consecutive locations (i.e., locations 9 and 10) that are holding the skip symbols in the elasticity FIFO 804.

In addition, the elasticity FIFO 806 illustrates positions of the two write and two read pointers after the adjustments in a next clock cycle (e.g., n+2). The two write pointers WR PTR0 and WR PTR1 write two data blocks (including data 44 and data 45) substantially simultaneously to two locations, i.e., locations 19 and 20, respectively, in the elasticity FIFO 806. The two read pointers RD PTR0 and RD PTR1 read two data blocks (including data 34 and data 35) substantially simultaneously from two locations, i.e., locations 9 and 10, respectively, in the elasticity FIFO 806. The two read pointers RD PTR0 and RD PTR1 retain in the two locations, i.e., locations 9 and 10, respectively, until the elasticity FIFO level reaches the predetermined elasticity FIFO threshold level.

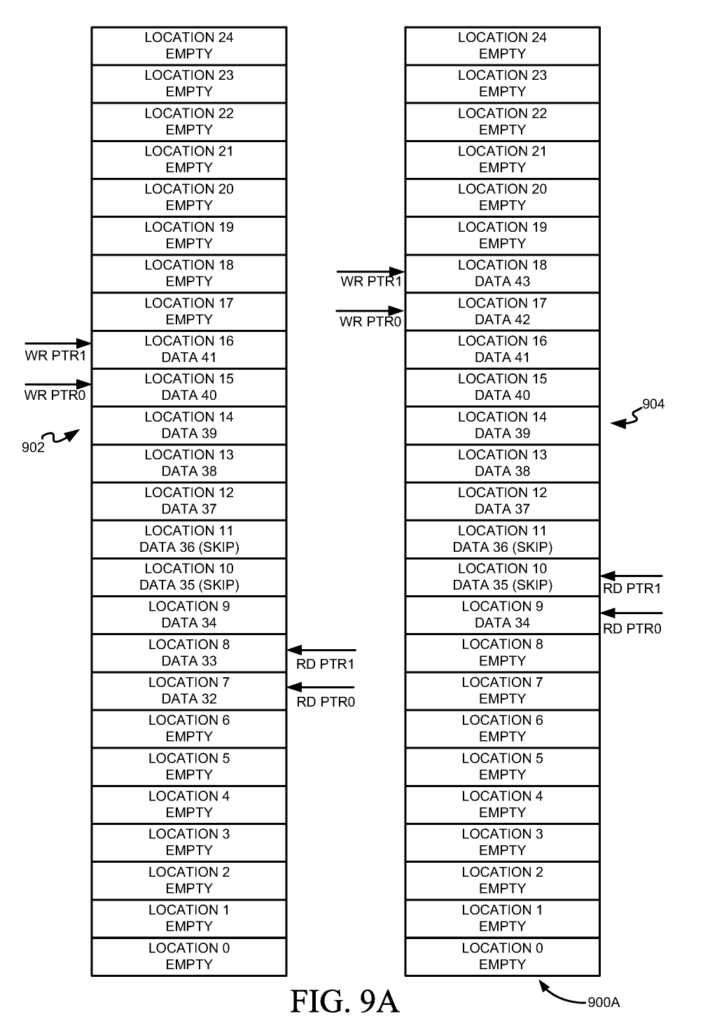

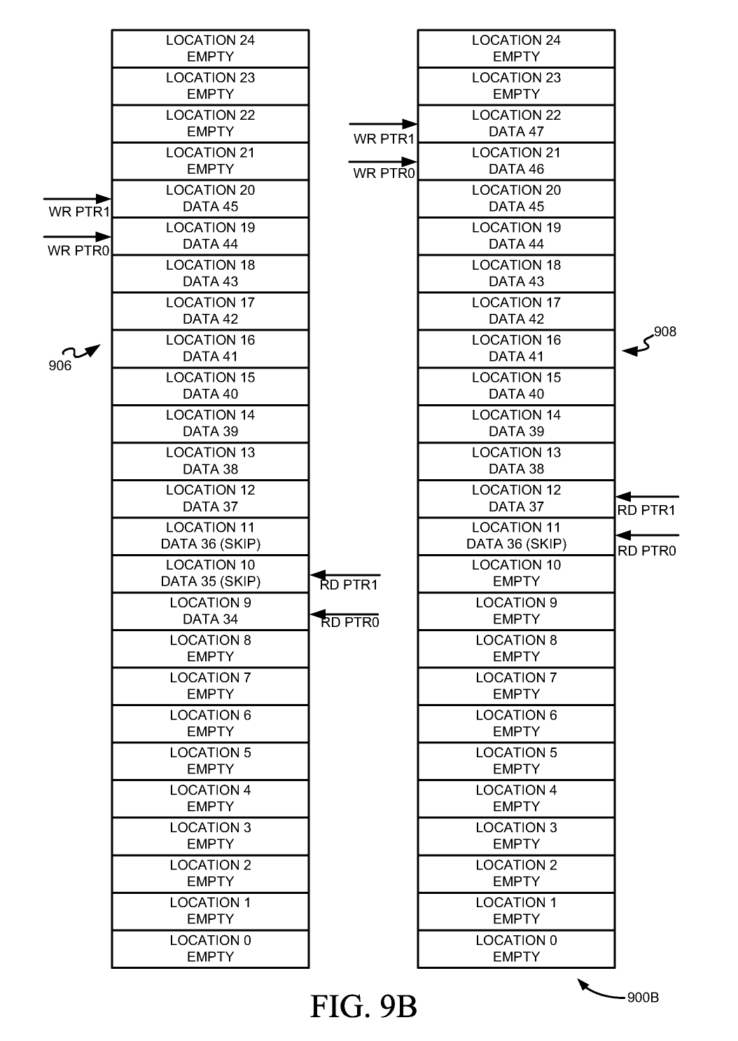

Referring now to FIG. 9A, a schematic illustrates elasticity FIFOs 902 and 904 (e.g., the elasticity FIFO 102 in FIG. 1) with two write and two read pointers making before and after adjustments to synchronize data transfer rate between the transmitter and the receiver in another scenario when an elasticity FIFO level is below the predetermined elasticity FIFO threshold level, according to an embodiment of the invention. The elasticity FIFOs 902 and 904 are similar to the elasticity FIFOs 202 and 204 shown in FIG. 2. Further, the elasticity FIFO 902 illustrates positions of the two write and two read pointers before adjustments in a clock cycle (e.g., n). The two write pointers WR PTR0 and WR PTR1 write two data blocks (including data 40 and data 41) substantially simultaneously to two locations, i.e., locations 15 and 16, respectively, in the elasticity FIFO 902. The two read pointers RD PTR0 and RD PTR1 read two data blocks (including data 32 and data 33) substantially simultaneously from two locations, i.e., locations 7 and 8, respectively, in the elasticity FIFO 802. In this embodiment, two consecutive locations, i.e., locations 10 and 11, in the elasticity FIFO 902 hold skip symbols (including data 35 and data 36).

Furthermore, the elasticity FIFO 904 illustrates position of the two write and two read pointers after the adjustments in a next clock cycle (e.g., n+1). The two write pointers WR PTR0 and WR PTR1 write two data blocks (including data 42 and data 43) substantially simultaneously to two locations, i.e., locations 17 and 18, respectively, in the elasticity FIFO 904. The two read pointers RD PTR0 and RD PTR1 read two data blocks (including data 34 and data 35) substantially simultaneously from two locations, i.e., locations 9 and 10, respectively, without skipping the two consecutive locations (i.e., locations 10 and 11) that are holding the skip symbols in the elasticity FIFO 904. The positions of the two write and two read pointers after the adjustments in next clock cycles (e.g., n+2 and n+3) are explained with reference to FIG. 9B.

Referring now to FIG. 9B, a schematic illustrates elasticity FIFOs 906 and 908 (e.g., the elasticity FIFO 102 in FIG. 1) with two write and two read pointers making before and after adjustments to synchronize data transfer rate between the transmitter and the receiver in another scenario when an elasticity FIFO level is below the predetermined elasticity FIFO threshold level, according to an embodiment of the invention. The elasticity FIFOs 906 and 908 are similar to the elasticity FIFOs 202 and 204 shown in FIG. 2. Further, the elasticity FIFO 906 illustrates positions of the two write and two read pointers after the adjustments in a next clock cycle (e.g., n+2). The two write pointers WR PTR0 and WR PTR1 write two data blocks (including data 44 and data 45) substantially simultaneously to two locations, i.e., locations 19 and 20, respectively, in the elasticity FIFO 906. The two read pointers RD PTR0 and RD PTR1 read two data blocks (including data 34 and data 35) substantially simultaneously from two locations, i.e., locations 9 and 10, respectively, in the elasticity FIFO 906. The two read pointers RD PTR0 and RD PTR1 retain in the two locations, i.e., locations 9 and 10, respectively, until the elasticity FIFO level reaches the predetermined elasticity FIFO threshold level.

Furthermore, the elasticity FIFO 908 illustrates positions of the two write and two read pointers after the adjustments in a next clock cycle (e.g., n+3). The two write pointers WR PTR0 and WR PTR1 write two data blocks (including data 46 and data 47) substantially simultaneously to two locations, i.e., locations 21 and 22, respectively, in the elasticity FIFO 908. The two read pointers RD PTR0 and RD PTR1 read two data blocks (including data 36 and data 37) substantially simultaneously from two locations, i.e., locations 11 and 12, respectively, in the elasticity FIFO 908. The RD PTR0 moves to next location (i.e., location 11) that is holding the skip symbol and the RD PTR1 moves to next location, i.e., location 12, in the elasticity FIFO 908.

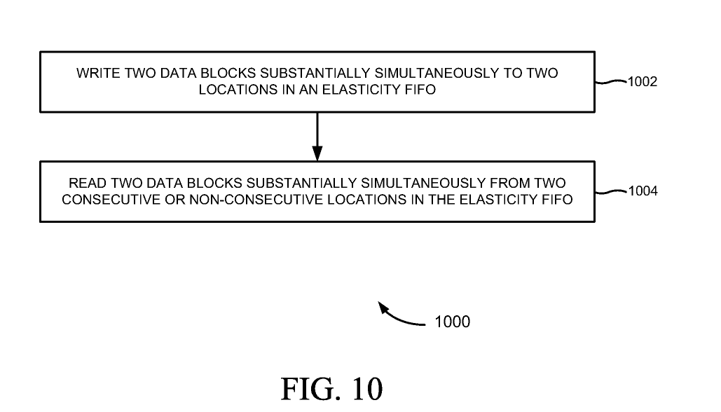

Referring now to FIG. 10, which illustrates a flow diagram 1000 of a method for processing an incoming data stream using a half-rate clock elasticity FIFO device, such as the one shown in FIG. 1, according to an embodiment of the invention. In this embodiment, the incoming data stream includes a continuous data stream including data blocks and skip symbols. The data blocks and the skip symbols include ordered sets. The skip symbols are a 10 bit symbols defined by Universal Serial Bus (USB) skip symbols. Further, the incoming data stream includes data, coming from a transmitter, formatted according to a standard communication protocol. Exemplary standard communication protocol includes a RapidIO, InfiniBand, Advanced Switching Interconnect, System Packet Interface, Fibre Channel, Serial Attached SCSI (SAS), Serial Advanced Technology Attachment (SATA), or any serial communication protocol with an embedded clock signal. The elasticity FIFO includes a plurality of locations to temporarily store the data blocks. Further, the plurality of locations is in a programmable range.

At block 1002, two data blocks are written substantially simultaneously to two locations in the elasticity FIFO specified by respective write pointers in a write clock cycle of a write clock. At block 1004, two data blocks are read substantially simultaneously from two consecutive or non-consecutive locations in the elasticity FIFO specified by two read pointers in a read clock cycle of a read clock. The two read pointers can independently adjust locations to read data from the plurality of locations based on a type of the data blocks in the elasticity FIFO and a predetermined elasticity FIFO threshold level in the read clock cycle to maintain an elasticity FIFO level at the predetermined elasticity FIFO threshold level to achieve a constant output rate. In one example embodiment, the predetermined elasticity FIFO threshold level includes a first predetermined number of locations filled with the data blocks that are waiting to be read.

In this embodiment, two data blocks are read substantially simultaneously from the two consecutive or non-consecutive locations in the elasticity FIFO specified by the two read pointers in the read clock cycle of the read clock upon the elasticity FIFO reaching the predetermined elasticity FIFO threshold level. The predetermined elasticity FIFO threshold level includes a second predetermined number of locations filled with the data blocks.

Further in these embodiments, the two read pointers can independently adjust the locations by determining a current elasticity FIFO level based on a number of the plurality of locations filled with the data blocks in each read clock cycle. In one example embodiment, if the current elasticity FIFO level is above the predetermined elasticity FIFO threshold level, then the two read pointers continue reading substantially the two locations specified by the two read pointers in each read clock cycle until they encounter one or more pairs of skip symbols stored in the plurality of locations. Upon encountering the one or more pairs of skip symbols the two read pointers continue reading next two locations including the data blocks upon skipping reading the one or more pairs of skip symbols stored in the plurality of locations.

In another example embodiment, if the current elasticity FIFO level is above the predetermined elasticity FIFO threshold level, then the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading next two consecutive or non-consecutive locations including the data blocks upon skipping reading part or all of incoming one or more skip symbols stored in the plurality of locations.

Furthermore, if the current elasticity FIFO level is below the predetermined elasticity FIFO threshold level, then the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading the encountered one or more skip symbols until the current elasticity FIFO level is equal to or above the predetermined elasticity FIFO threshold level. In addition, if the current elasticity FIFO level is equal to the predetermined elasticity FIFO threshold level, then the two read pointers continue reading substantially the two locations specified by the two read pointers in each read clock cycle without skipping any encountered one or more pairs of skip symbols stored in the plurality of locations.

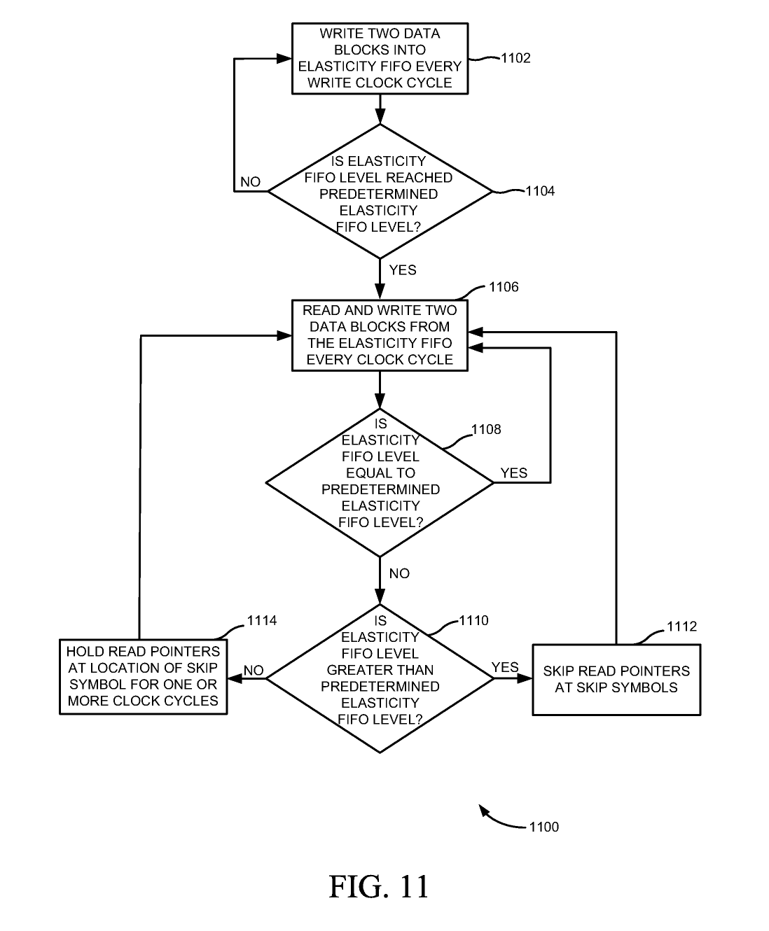

Referring now to FIG. 11, which illustrates another flow diagram 1100 of a method for processing an incoming data stream using a half-rate clock elasticity FIFO device, such as the one shown in FIG. 1, according to an embodiment of the invention. At block 1102, two data blocks are written to the elasticity FIFO in each write clock cycle. At block 1104, a check is made to determine whether current elasticity FIFO level reaches a predetermined elasticity FIFO threshold level during each write clock cycle. If the current elasticity FIFO level reaches the predetermined elasticity FIFO threshold level, at block 1106, two data blocks are written substantially simultaneously to two locations in the elasticity FIFO in a write clock cycle of a write clock and two data blocks are read substantially simultaneously from two locations in the elasticity FIFO in a read clock cycle of a read clock. If the current elasticity FIFO level does not reaches the predetermined elasticity FIFO threshold level then the process goes to the block 1102 and repeats the process.

At block 1108, a check is made to determine whether the current elasticity FIFO level is equal to the predetermined elasticity FIFO threshold level. If the current elasticity FIFO level is equal to the predetermined elasticity FIFO threshold level then the process goes to the block 1106 and repeats the process. If the current elasticity FIFO level is not equal to the predetermined elasticity FIFO threshold level, at block 1110, a check is made to determine whether the current elasticity FIFO level is greater than the predetermined elasticity FIFO threshold level. If the current elasticity FIFO level is greater than the predetermined elasticity FIFO threshold level, at block 1112, the two read pointers are skipped over the locations in the elasticity FIFO holding skip symbols. If the current elasticity FIFO level is less than the predetermined elasticity FIFO threshold level, at block 1114, the two read pointers retain over the locations in the elasticity FIFO holding skip symbols for one or more read clock cycles. This is explained in more detail with reference to FIGS. 2-9.

In various embodiments, the device and methods described in FIGS. 1 through 11 propose the half-rate clock elasticity FIFO device that substantially simultaneously write two data blocks and substantially simultaneously read two data blocks in each clock cycle and thus eliminates need for high speed clock. Hence, physical implementation of the elasticity FIFO for varying incoming and outgoing data transfer rates is made easier. Adjusting two read pointers of the elasticity FIFO by skipping the locations holding the skip symbols reduces latency time between a write and associated read of the data blocks. Reducing the latency time further reduces the power consumption of the elasticity FIFO in the receiver. The device and methods described above reduces the gate count and area needed for the elasticity FIFO on the silicon chip of the receiver by reducing the need to increase the elasticity FIFO size. This also reduces the cost contribution of the elasticity FIFO.

Further, even though the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method of data stream processing in an elasticity first in first out (FIFO) including a plurality of locations to temporarily store data blocks, comprising:
substantially simultaneously writing two data blocks to two locations in the elasticity FIFO specified by respective two write pointers in a write clock cycle of a write clock; and
substantially simultaneously reading two data blocks from two consecutive or non-consecutive locations in the elasticity FIFO specified by two read pointers in a read clock cycle of a read clock, wherein the two read pointers can independently adjust locations to read in the plurality of locations based on a type of the data blocks in the elasticity FIFO and a predetermined elasticity FIFO threshold level in the read clock cycle to maintain the elasticity FIFO level at the predetermined elasticity FIFO threshold level to achieve a constant output rate.

2. The method of claim 1, wherein the data stream comprises a continuous data stream including the data blocks and skip symbols and wherein the data stream being data coming from a transmitter formatted according to a standard communication protocol.

3. The method of claim 2, wherein the standard communication protocol is one of the group comprising: RapidIO, InfiniBand, Advanced Switching Interconnect, System Packet Interface, Fibre Channel, Serial Attached SCSI (SAS), Serial Advanced Technology Attachment (SATA), and any serial communication protocol with an embedded clock signal.

4. The method of claim 2, wherein the pair of skip symbols are a pair of 10 bit symbols defined by USB skip symbols.

5. The method of claim 1, wherein the data blocks and the skip symbols comprise ordered sets.

6. The method of claim 1, wherein the plurality of locations is in a programmable range.

7. The method of claim 1, wherein the predetermined elasticity FIFO threshold level includes a first predetermined number of locations filled with the data blocks that are waiting to be read.

8. The method of claim 7, wherein substantially simultaneously reading the two data blocks from the two consecutive or non-consecutive locations in the elasticity FIFO specified by the two read pointers in the read clock cycle of the read clock comprises:
substantially simultaneously reading the two data blocks from the two consecutive or non-consecutive locations in the elasticity FIFO specified by the two read pointers in the read clock cycle of the read clock upon the elasticity FIFO reaching the predetermined elasticity FIFO threshold level, wherein the predetermined elasticity FIFO threshold level includes a second predetermined number of locations filled with the data blocks.

9. The method of claim 8, wherein the two read pointers can independently adjust the locations to read in the plurality of locations based on the type of the data blocks in the elasticity FIFO and the predetermined elasticity FIFO threshold level in the read clock cycle to maintain the elasticity FIFO level at the predetermined elasticity FIFO threshold level to achieve the constant output rate, comprises:
determining current elasticity FIFO level based on a number of the plurality of locations filled with the data blocks in each read clock cycle;
if the current elasticity FIFO level is above the predetermined elasticity FIFO threshold level, then the two read pointers continue reading substantially the two locations specified by the two read pointers in each read clock cycle until they encounter one or more pairs of skip symbols stored in the plurality of locations and upon encountering the one or more pairs of skip symbols the two read pointers continue reading next two locations including the data blocks upon skipping reading part or all of incoming one or more skip symbols stored in the plurality of locations;
if the current elasticity FIFO level is below the predetermined elasticity FIFO threshold level, then the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading the encountered one or more skip symbols until the current elasticity FIFO level is equal to or above the predetermined elasticity FIFO threshold level; and
if the current elasticity FIFO level is equal to the predetermined elasticity FIFO threshold level, then the two read pointers continue reading substantially the two locations specified by the two read pointers in each read clock cycle without skipping any encountered one or more pairs of skip symbols stored in the plurality of locations.

10. The method of claim 9, wherein the two read pointers can independently adjust locations to read in the plurality of locations based on the type of the data blocks in the elasticity FIFO and the predetermined elasticity FIFO threshold level and current fill level of elasticity FIFO in the read clock cycle to maintain elasticity FIFO fill level at predetermined elasticity FIFO threshold level to achieve the constant output rate comprises:
if the current elasticity FIFO fill level is above the predetermined elasticity FIFO threshold level, then the two read pointers continue reading substantially the two read locations specified by the two read pointers in each read clock cycle until they encounter the one or more pairs of skip symbols stored in the plurality of locations and upon encountering the one or more pairs of skip symbols the two read pointers continue reading next two consecutive or non-consecutive locations including the data blocks upon skipping reading part or all of incoming one or more skip symbols stored in the plurality of locations.

11. A half-rate clock elasticity FIFO device coupled to a communication or storage system for receiving data from a network, comprising:
a write pointer generation module;
a read pointer generation module coupled to the write pointer generation module; and
an elasticity FIFO, including a plurality of locations to temporarily store data blocks, coupled to the write pointer generation module and the read pointer generation module, wherein the write pointer generation module generates two write pointers and substantially simultaneously writes two data blocks to two locations in the elasticity FIFO specified by the respective two write pointers in a write clock cycle of a write clock, and wherein the read pointer generation module generates two read pointers and substantially simultaneously reads two data blocks from two consecutive or non-consecutive locations in the elasticity FIFO specified by the two read pointers in a read clock cycle of a read clock, wherein the two read pointers generated by the read pointer generation module independently adjust locations to read in the plurality of locations based on a type of the data blocks in the elasticity FIFO and a predetermined elasticity FIFO threshold level in the read clock cycle to maintain the elasticity FIFO level at the predetermined elasticity FIFO threshold level to achieve a constant output rate.

12. The device of claim 11, wherein the data stream comprises a continuous data stream including the data blocks and skip symbols and wherein the data stream being data coming from a transmitter formatted according to a standard communication protocol.

13. The device of claim 12, wherein the standard communication protocol is one of the group comprising: RapidIO, InfiniBand, Advanced Switching Interconnect, System Packet Interface, Fibre Channel, Serial Attached SCSI (SAS), Serial Advanced Technology Attachment (SATA), and any serial communication protocol with an embedded clock signal.

14. The device of claim 12, wherein the skip symbols are a pair of 10 bit symbols defined by PCI express symbols or USB skip symbols.

15. The device of claim 11, wherein the data blocks and the skip symbols comprise ordered sets.

16. The device of claim 11, wherein the plurality of locations is in a programmable range.

17. The device of claim 11, wherein the predetermined elasticity FIFO threshold level includes a first predetermined number of locations filled with the data blocks that are waiting to be read.

18. The device of claim 17, wherein the read pointer generation module substantially simultaneously reads the two data blocks from the two consecutive or non-consecutive locations in the elasticity FIFO specified by the two read pointers in the read clock cycle of the read clock upon the elasticity FIFO reaching a predetermined read elasticity FIFO level, wherein the predetermined read elasticity FIFO level includes a second predetermined number of locations filled with the data blocks.

19. The device of claim 18, wherein the write pointer generation module determines current elasticity FIFO level based on a number of the plurality of locations filled with the data blocks in each read clock cycle, wherein the read pointer generation module via the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading next two locations including data blocks upon skipping reading the part or all of incoming one or more pairs of skip symbols stored in the plurality of locations when the current elasticity FIFO level is above the predetermined elasticity FIFO threshold level,
wherein the read pointer generation module via the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading the encountered one or more skip symbols until the current elasticity FIFO level is equal to or above the predetermined elasticity FIFO threshold level when the current elasticity FIFO level is below the predetermined elasticity FIFO threshold level, and
wherein the read pointer generation module via the two read pointers continue reading substantially the two locations specified by the two read pointers in each read clock cycle without skipping any encountered one or more pairs of skip symbols stored in the plurality of locations when the current elasticity FIFO level is equal to the predetermined elasticity FIFO threshold level.

20. The device of claim 19, wherein the read pointer generation module via the two read pointers continue reading substantially the two locations specified by the two read pointers in each read clock cycle until they encounter the one or more pairs of skip symbols stored in the plurality of locations and upon encountering the one or more pairs of skip symbols the two read pointers continue reading next two consecutive or non-consecutive locations including the data blocks upon skipping reading the one or more pairs of skip symbols stored in the plurality of locations when the current elasticity FIFO level is above the predetermined elasticity FIFO threshold level.
